(19) United States
(12) Patent Application Publication
(10) Pub. No.: US 2012/0205240 A1
(43) Pub. Date: Aug. 16, 2012

(54) PROCESS FOR THE PRODUCTION OF GRAPHITE ELECTRODES FOR ELECTROLYTIC PROCESSES

(75) Inventors: Rainer Weber, Odenthal (DE); Jürgen Kintrup, Emsdetten (DE); Matthias Weis, Leverkusen (DE); Odo Muddemann, Koln (DE); Gerhard Moormann, Brunsbuttel (DE); Frank Rauscher, Koln (DE)

(73) Assignee: Bayer MaterialScience AG, Leverkusen (DE)

(21) Appl. No.: 13/454,675

(22) Filed: Apr. 24, 2012

Related U.S. Application Data
(63) Continuation of application No. 12/209,350, filed on Sep. 12, 2008, now abandoned.

(30) Foreign Application Priority Data
Sep. 15, 2007 (DE) 10 2007 044 171.3

(51) Int. Cl. C25B 11/12; B05D 5/12

(52) U.S. Cl. 204/290.14; 427/77

(57) ABSTRACT

A process is described for the production of graphite electrodes coated predominantly with noble metal for electrolytic processes, especially for the electrolysis of hydrochloric acid, wherein the surface of a graphite electrode is coated with an aqueous solution of a noble metal compound and then tempered at 150 to 650° C. in the presence of reducing and/or extensively oxygen-free gases.

### RELATED APPLICATIONS

This application claims benefit to German Patent Application No. 10 2007 044 171.3, filed Sep. 15, 2007, which is incorporated herein by reference in its entirety for all useful purposes.

### BACKGROUND OF THE INVENTION

The invention relates to a process for the production of graphite electrodes coated with finely divided iridium for electrolytic processes, especially for the electrolysis of hydrochloric acid.

A process for the electrolysis of hydrochloric acid is described in Ullmanns Encyclopedia of Industrial Chemistry, Chlorine 10.1 Electrolysis of Hydrochloric Acid, 2006, Wiley-VCH Verlag. The electrolysers typically used for the electrolysis of hydrochloric acid consist of bipolar-connected graphite electrode plates arranged in series according to the filter press principle. Anode and cathode chambers are normally separated by a diaphragm or a cation exchange membrane. Conventionally, chlorine is produced on the anode side and hydrogen on the cathode side. Noble metal salts, e.g. platinum, palladium and rhodium salts, are added continuously or batchwise to the cathode chambers of the electrolysers in order to lower the hydrogen deposition voltage and hence the cell voltage, metallic noble metal being deposited on the graphite electrodes. One substantial disadvantage of this procedure is that the deposition of noble metal only produces the desired voltage lowering effect for a short time and therefore has to be constantly renewed, resulting, inter alia, in a high consumption of noble metal. According to EP 683 247 A1, another disadvantage is that noble metals can be deposited in the entire apparatus system downstream of the cells.

EP 683 247 A1 describes a process for the production of graphite electrodes in which noble metal coatings, e.g. iridium and/or rhodium coatings, are produced in the pores of the graphite surface. The graphite electrodes according to EP 683 247 A1 are produced by introducing, into the graphite, solutions of iridium salts or rhodium salts, or mixtures of iridium salts or rhodium salts with salts of the other platinum group metals, in monohydric or polyhydric alcohols having 2 to 4 carbon atoms or in alcohol mixtures. The surface of the graphite body impregnated with the solution is then heated for 2 to 10 minutes at a temperature between 200 and 450° C., to a depth of up to about 1 mm, with open gas flames, which are applied to the impregnated graphite body, vertically from top to bottom, only when the whole of the impregnated graphite body is situated below the gas flames.

### EMBODIMENTS OF THE INVENTION

An embodiment of the present invention is a process for producing graphite electrodes coated predominantly with noble metal for electrolytic processes comprising (1) coating the surface of a graphite electrode with an aqueous solution of a noble metal compound, (2) removing the solvent, and (3) tempering the graphite electrode at 150 to 650° C. in the presence of reducing and/or extensively oxygen-free gases.

Another embodiment of the present invention is the above process, wherein said electrolysis process is the electrolysis of hydrochloric acid.

Another embodiment of the present invention is the above process, wherein said noble metal compound is at least one compound selected from the group comprising iridium, ruthenium, rhodium, platinum, and palladium compounds, or mixtures thereof.

Another embodiment of the present invention is the above process, wherein said noble metal compound is a salt of an inorganic or organic acid or a complex compound.

Another embodiment of the present invention is the above process, wherein said noble metal compound is an iridium, ruthenium, rhodium, platinum, or palladium halide, acetate, oxalate, nitrate, or pentanedionate.

Another embodiment of the present invention is the above process, wherein said noble metal compound is an iridium, ruthenium, rhodium, platinum, or palladium halide.

Another embodiment of the present invention is the above process, wherein said noble metal compound is an iridium, ruthenium, rhodium, platinum, or palladium chloride.

Another embodiment of the present invention is the above process, wherein said noble metal compound is iridium chloride.

Another embodiment of the present invention is the above process, wherein said iridium chloride is IrCl₃, IrCl₄, or a mixture of IrCl₃ and IrCl₄.

Another embodiment of the present invention is the above process, wherein the noble metal coating produced contains 5 to 40 g/m² of noble metal, based on the area of the graphite electrode.

Another embodiment of the present invention is the above process, wherein the noble metal coating produced contains 7.5 to 20 g/m² of noble metal, based on the area of the graphite electrode.

Another embodiment of the present invention is the above process, wherein said tempering takes place at 200 to 450° C.

Another embodiment of the present invention is the above process, wherein said tempering takes place at 250 to 350° C.

Another embodiment of the present invention is the above process, wherein said reducing and/or extensively oxygen-free gases consist of a gaseous mixture of a chemically inert gas.

Another embodiment of the present invention is the above process, wherein said gaseous mixture of a chemically inert gas is a mixture of nitrogen or a noble gas, with hydrogen.

Another embodiment of the present invention is the above process, wherein the proportion of hydrogen in said mixture ranges from 1 to 5.5 volume %.

Another embodiment of the present invention is the above process, wherein the treatment time of said tempering is 1 to 5 hours.

Another embodiment of the present invention is the above process, wherein said treatment time is 2 to 3 hours.

Another embodiment of the present invention is the above process, wherein the proportion of oxygen in said reducing and/or extensively oxygen-free gas is at most 5 volume %.

Another embodiment of the present invention is the above process, wherein the proportion of oxygen in said reducing and/or extensively oxygen-free gas is at most 3 volume %.

Another embodiment of the present invention is the above process, wherein the proportion of oxygen in said reducing and/or extensively oxygen-free gas is at most 1 volume %.

Yet another embodiment of the present invention is a graphite electrode prepared according to the above process.

### DESCRIPTION OF THE INVENTION

This process produces a noble metal coating that is stable for a certain time under the operating conditions of hydrochloric acid electrolysis and does not have to be renewed.

Disadvantages of the process according to EP 683 247 A1 are the fact that the lowering of the overvoltage at the electrodes modified by this process is still not optimal in the electrolysis, the use of alcoholic solvents, which can form explosive mixtures in air and therefore demand special safety measures in this process operating with open flames, and the fact that the temperature control during heating is imprecise due to large temperature differences between the gas flame used, the impregnated graphite surface and the bulk of the graphite.

The object of the invention is to provide an improved process for the production of graphite electrodes for electrolytic processes which does not exhibit the aforementioned disadvantages.

The invention provides a process for the production of graphite electrodes coated predominantly with noble metal for electrolytic processes, especially for the electrolysis of hydrochloric acid, which is characterized in that the surface of the graphite electrode is coated with an aqueous solution of a noble metal compound, the solvent is removed and the graphite electrode is then tempered at 150 to 650° C. in the presence of reducing and/or extensively oxygen-free gases.

In particular, the finished coating on the electrode contains at least 95 wt. %, preferably at least 99 wt. %, of noble metal.

The noble metal compound used consists in particular of at least one compound from the group comprising iridium, ruthenium, rhodium, platinum and palladium compounds, especially salts of inorganic or organic acids or complex compounds, on its own or in any desired mixture. It is preferable to use iridium, ruthenium, rhodium, platinum or palladium halides, acetates, oxalates, nitrates or pentanedionates, and particularly preferable to use halides of said noble metals, especially noble metal chlorides. It is particularly preferable to use an iridium chloride, which can be e.g. IrCl₃ or IrCl₄ or a mixture of the two. As water is used as solvent, said compounds can also contain water of hydration. However, it is also possible, for example, to use an acidic iridium halide solution, e.g. hexachloroiridic(IV) acid.

The aqueous solution of noble metal compounds can additionally contain surface-active substances, especially surfactants, other salts or, in particular, mineral acids, and also water-miscible organic solvents, especially alcohols or ketones.

The amount of noble metal compound is preferably proportioned so that the coating produced contains 5 to 40 g/m², preferably 7.5 to 20 g/m², of noble metal, based on the area of the graphite electrode, i.e. the geometric surface area defined by the external dimensions (edge lengths).

In one preferred variant of the process according to the invention, the treatment in the reducing and/or extensively oxygen-free gas atmosphere takes place at 200 to 450° C., particularly preferably at 250 to 350° C.

The treatment takes place in particular in an oven or heating cabinet with the gases flowing over the coated surface of the electrode. For this purpose the oven or heating cabinet has e.g. a gas inlet orifice and a gas outlet and is sealed against the admission of air from outside. For example, if the oven is not completely gastight, its interior chamber can be operated at a slightly higher pressure than the surrounding atmospheric air in order to prevent air from entering. In particular, the treatment is carried out with a residual air concentration of at most 25 vol. %, preferably of at most 5 vol. % and particularly preferably of at most 2 vol. %. The proportion of oxygen in the tempering gas is particularly at most 5 vol. %, preferably at most 3 vol. % and particularly preferably at most 1 vol. %.

Preferably, the gas atmosphere used consists of an inert gas, especially nitrogen or a noble gas, preferably helium, argon, neon, krypton, radon or xenon, or carbon dioxide, or a gaseous mixture of one of said inert gases with hydrogen, or pure hydrogen. The proportion of hydrogen can thus range from 0 vol. % (pure inert gas) to 100 vol. % (pure hydrogen), but it is preferable to use a hydrogen concentration ranging from 1 to 5.5 vol. %. The inert gas used is particularly preferably nitrogen. Hydrogen/nitrogen mixtures that are suitable in principle are commercially available in ready-mixed form under the name of forming gas.

The treatment time in the reducing and/or extensively oxygen-free gas atmosphere is preferably 1 to 5 hours and particularly preferably 2 to 3 hours.

In one preferred embodiment of the invention, after the oven has been loaded with one or more graphite electrodes, it is closed and initially flushed at room temperature with the above-described gas atmosphere until the residual air concentration is below 25 vol. %, preferably below 5 vol. % and particularly preferably below 1 vol. %. The oven is then heated to the target temperature and left at this temperature for the chosen treatment time, while still being flushed with gas during both these operations. The oven chamber is then left to cool, while still being flushed with gas, and the contents are removed once the temperature has fallen below 100° C., preferably below 50° C.

The invention also provides graphite electrodes coated with noble metal which are obtained by the novel coating process.

The graphite electrodes coated by the process according to the invention are outstandingly suitable for the production of chlorine and hydrogen by the electrolysis of hydrochloric acid.

The invention therefore also provides the use of graphite electrodes coated with noble metal, obtained by the novel coating process, as electrodes (cathodes and/or anodes) in the production of chlorine and hydrogen by the electrolysis of hydrochloric acid.

The HCl concentration in the electrolysis of hydrochloric acid with the graphite electrodes coated according to the invention can be 5 to 36 wt. %. The hydrochloric acid used normally has an HCl concentration of between 10 and 30 wt. %. The HCl concentration is preferably in the range from 15 to 25 wt. %.

The electrolysis of hydrochloric acid with the graphite electrodes coated according to the invention is conventionally operated at a temperature of 30 to 100° C., preferably of 50 to 100° C. and particularly preferably of 70 to 90° C.

The graphite electrodes coated according to the invention are preferably produced using electrode graphite (graphite for technical electrolytic processes), e.g. a grade of graphite such as AX from Graphite COVA GmbH, Röthenbach, or HL, ML or AL graphite marketed by SGL Carbon GmbH, Meitingen. Such particularly suitable types of graphite usually have a characteristic porosity (cumulative pore volume) of 12 to 23%, the resistivity is 5.0 to 12.5 μΩm, the bulk density is 1.60 to 1.80 g/cm³ and the ash content is below 0.1%.

To improve the discharge of the gases formed in the electrolysis (anode: chlorine, cathode: hydrogen), the surface of the graphite electrodes can be structured e.g. by the introduction of 1 mm to 3 mm wide slits 10 to 30 mm deep, spaced 3 to 7 mm apart. The novel coating process is found to be particularly advantageous in the case of graphite electrodes with a structured surface because of the greater uniformity of the coating.

The diaphragms preferably used to separate anode and cathode chambers in diaphragm electrolysis are preferably made of PVC fabric, mixed PVC/PVDF fabric or PVDF fabric.

Membranes made of polyfluorosulfonic acids (e.g. Nafion® 430 membranes from DuPont) can also be used as an alternative.

The hydrochloric acid that is preferably to be used in electrolysis with the graphite electrodes coated according to the invention is obtained e.g. in the synthesis of organic compounds such as polyisocyanates. It has proved advantageous to remove impurities, especially organic impurities, from the hydrochloric acid before it enters the electrolysis cells. This is done by treating the hydrochloric acid with activated charcoal. Alternatively, it can be also be treated with ozone or extractants. Inorganic impurities can be removed by ion exchange methods.

The invention is illustrated in greater detail below with the aid of the following Examples.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Example 1 (Comparative Example)

Hydrochloric acid was electrolysed in an electrolysis cell having a PVC diaphragm and two uncoated graphite electrodes (AX-20 from COVA), each of which had an area of 100 mm×100 mm, a thickness of 60 mm and fourteen 5 mm wide lands structured by means of 13 slits approx. 2 mm wide and 19 mm deep. The hydrochloric acid was pumped round an internal circuit at a rate of 6 l/h in both electrode chambers. The distance between the surfaces of the cathode and anode (both vertical) was 5 mm and the slits were in the vertical direction. The cell housing was made of acid-resistant and chlorine-resistant plastic. The cathode and anode were sealed into the cell housing with current supply pins. The two halves of the cell were separated by a PVC diaphragm. The electrolyte could be pumped round both halves of the cell, the throughput being varied in the range between 2 l/h and 10 l/h. Fresh 30% hydrochloric acid was introduced into these circuits by means of metering pumps in such a way that the subsequent concentration of hydrochloric acid in the electrolyte chambers during electrolysis was about 20 wt. %. The product gases and the impoverished electrolytes leave the cell via gas/liquid separators. A current of 50 A, i.e. a current density of 5 kA/m², was established by means of an electrical power generator. The resultant cell voltage was measured at the front edges of the electrodes with two graphite tips, each insulated in the feed.

After a running-in period of 5 days, the cell voltage was 1.97 volt at a temperature of 75° C.

The PVC diaphragm was then exchanged for a Nafion® 430 cation exchange membrane from DuPont. After a running-in period of 7 days, the cell voltage was 1.99 volt at a temperature of 81° C.

### Example 2 (Comparative Example)

0.286 g of iridium(IV) chloride hydrate (IrCl₄.H₂O, Ir content 52.23 wt. %) was dissolved in 1.245 ml of 1,2-ethanediol. Using a paintbrush, all of this solution was uniformly applied to the 14 land surfaces (5 mm×100 mm each) of a graphite electrode having the same structure and size as in Example 1. The amount of iridium applied was 15.0 g/m², based on the geometric area of the graphite electrode (100 min×100 mm). After approx. 15 minutes the side treated with the solution (subsequently the cathode side in the electrolysis) was heated for 5 minutes with a flame from a butane/propane gas burner, a temperature of 450° C. being reached after 5 minutes and the plate already being situated below the burner before the flame was ignited. After cooling to below 90° C., the land surfaces of the graphite electrode were uniformly coated with 1.245 ml of 1,2-ethanediol (without addition of metal salt) and the heating was then repeated immediately (without a waiting time). The graphite plate was built as the cathode into the electrolysis cell described in Example 1. With electrolyte throughputs of 6 l/h and using a PVC diaphragm, the resultant cell voltage, which remained constant for 8 days, was 1.77 volt at a current density of 5 kA/m² and a temperature of 75° C.

### Example 3 (Inventive Example)

0.289 g of iridium(IV) chloride hydrate (IrCl₄.H₂O, Ir content 52.23 wt. %) was dissolved in 1.512 g of deionized water. Using a paintbrush, all of the solution was applied to the 14 land surfaces (5 mm×100 mm each) of a graphite electrode having the same structure and size as in Example 1 to give an iridium loading of 15.0 g/m², based on the area of the graphite electrode (100 mm×100 mm). The coated electrode block was then immediately treated in a vertical tube oven having an internal diameter of 15 cm and an internal volume of approx. 5 l, the electrode block initially being flushed for a period of 30 minutes at room temperature with a gaseous mixture consisting of 5 vol. % of hydrogen and 95 vol. % of nitrogen at a volumetric flow rate of 50 l/h. The oven was then heated to 250° C. at a rate of approx. 10° C./minute and the electrode block was tempered for a period of 3 h with the gas still flowing. The oven heating was then switched off and the electrode block was cooled with the gas still flowing. After approx. 3 hours the oven temperature had cooled to below 100° C., the gas flow was switched off and the closed oven cooled further overnight to a temperature below 50° C.; only then was it opened to remove the electrode.

The finished graphite electrode was built as the cathode into the electrolysis cell described in Example 1. With an electrolyte throughput of 6 l/h and using a PVC diaphragm, the resultant cell voltage on the fifth day of operation was 1.59 volt at a current density of 5 kA/m² and a temperature of 75° C. The experiment was continued for a period of up to 150 days with cut-offs and variations in the current density and temperature, but there was no detectable loss of quality.

### Example 4 (Inventive Example)

0.289 g of iridium(IV) chloride hydrate (IrCl₄.H₂O, Ir content 52.23 wt. %) was dissolved in 1.525 g of deionized water and applied to the land surfaces of a graphite electrode as in Example 3. The subsequent treatment in the oven was also carried out as in Example 3, the only difference being that the oven was heated to a temperature of 450° C. and the treatment time at this temperature was 2 h.

The finished graphite electrode was built as the cathode into the electrolysis cell described in Example 1. With an electrolyte throughput of 6 l/h and using a PVC diaphragm, the resultant cell voltage on the eighth day of operation was 1.73 volt at a current density of 5 kA/m² and a temperature of 74° C. The experiment was continued for a period of up to 45 days with cut-offs and variations in the temperature, but there was no detectable loss of quality.

### Example 5 (Inventive Example)

0.190 g of ruthenium(III) chloride hydrate (RuCl₃.H₂O, Ru content 40.07 wt. %) and 0.143 g of iridium(IV) chloride hydrate (IrCl₄.H₂O, Ir content 52.23 wt. %) were dissolved in 1.504 g of deionized water. Using a paintbrush, all of the solution was applied to the 14 land surfaces (5 mm×100 mm each) of a graphite electrode having the same structure and size as in Example 1 to give a ruthenium loading of 7.6 g/m² and an iridium loading of 7.5 g/m², based on the area of the graphite electrode (100 mm×100 mm).

The oven treatment was carried out analogously to Example 3.

The finished graphite electrode was built as the cathode into the electrolysis cell described in Example 1. With an electrolyte throughput of 6 l/h and using a Nafion® 430 cation exchange membrane, the resultant cell voltage on the fifth day of operation was 1.66 volt at a current density of 5 kA/m² and a temperature of 67° C.

1. A process for producing graphite electrodes coated predominantly with noble metal for electrolytic processes comprising (1) coating the surface of a graphite electrode with an aqueous solution of a noble metal compound, (2) removing the solvent, and (3) tempering the graphite electrode at 150 to 650° C. in the presence of reducing and/or extensively oxygen-free gases.

2. The process of claim 1, wherein said electrolysis process is the electrolysis of hydrochloric acid.

3. The process of claim 1, wherein said noble metal compound is at least one compound selected from the group comprising iridium, ruthenium, rhodium, platinum, and palladium compounds, or mixtures thereof.

4. The process of claim 3, wherein said noble metal compound is a salt of an inorganic or organic acid or a complex compound.

5. The process of claim 4, wherein said noble metal compound is an iridium, ruthenium, rhodium, platinum, or palladium halide, acetate, oxalate, nitrate, or pentanedionate.

6. The process of claim 5, wherein said noble metal compound is an iridium, ruthenium, rhodium, platinum, or palladium halide.

7. The process of claim 6, wherein said noble metal compound is an iridium, ruthenium, rhodium, platinum, or palladium chloride.

8. The process of claim 7, wherein said noble metal compound is iridium chloride.

9. The process of claim 8, wherein said iridium chloride is IrCl₃, IrCl₄, or a mixture of IrCl₃ and IrCl₄.

10. The process of claim 1, wherein the noble metal coating produced contains 5 to 40 g/m² of noble metal, based on the area of the graphite electrode.

11. The process of claim 10, wherein the noble metal coating produced contains 7.5 to 20 g/m² of noble metal, based on the area of the graphite electrode.

12. The process of claim 1, wherein said tempering takes place at 200 to 450° C.

13. The process of claim 12, wherein said tempering takes place at 250 to 350° C.

14. The process of claim 1, wherein said reducing and/or extensively oxygen-free gases consist of a gaseous mixture of a chemically inert gas.

15. The process of claim 14, wherein said gaseous mixture of a chemically inert gas is a mixture of nitrogen or a noble gas, with hydrogen.

16. The process of claim 15, wherein the proportion of hydrogen in said mixture ranges from 1 to 5.5 volume %.

17. The process of claim 1, wherein the treatment time of said tempering is 1 to 5 hours.

18. The process of claim 17, wherein said treatment time is 2 to 3 hours.

19. The process of claim 1, wherein the proportion of oxygen in said reducing and/or extensively oxygen-free gas is at most 5 volume %.

20. The process of claim 19, wherein the proportion of oxygen in said reducing and/or extensively oxygen-free gas is at most 3 volume %.

21. The process of claim 20, wherein the proportion of oxygen in said reducing and/or extensively oxygen-free gas is at most 1 volume %.

22. A graphite electrode prepared according to the process of claim 1.
